(19) United States
(12) Patent Application Publication
(10) Pub. No.: US 2010/0311905 A1
(43) Pub. Date: Dec. 9, 2010

(54) METHOD FOR PREPARING THERMOPLASTIC COMPOSITIONS BASED ON PLASTICIZED STARCH AND RESULTING COMPOSITIONS

(75) Inventors: Leon Mentink, Lille (FR); Didier Lagneaux, Bluffy (FR); Jerome Gimenez, Villeurbanne (FR)

Correspondence Address: YOUNG & THOMPSON, 209 Madison Street, Suite 500, Alexandria, VA, 22314, US

(73) Assignee: ROQUETTE FRERES, Lestrem (FR)

(21) Appl. No.: 12/864,765

(22) PCT Filed: Jan. 29, 2009
(86) PCT No.: PCT/FR2009/050131

§ 371 Date: Jul. 27, 2010

(30) Foreign Application Priority Data
Feb. 1, 2008 (FR) 0850660

(51) Int. Cl. C08B 31/00

(52) U.S. Cl. 525/54.31

(57) ABSTRACT

A method for preparing a starch-based thermoplastic composition, includes the following steps: (a) selecting at least one granular starch and at least one organic plasticizer for this starch, (b) preparing a plasticized composition by thermomechanically mixing this starch and this plasticizer, (c) optionally incorporating at least one functional substance carrying functions including an active hydrogen, (d) incorporating at least one bonding agent carrying at least two functional groups capable of reacting with molecules carrying functions including an active hydrogen, and optionally (e) heating the mixture to a temperature sufficient to cause the bonding agent to react with the plasticizer and with the starch and/or the functional substance, it being possible for steps (d) and (e) to be carried out simultaneously, and also a starch-based thermoplastic composition that can be obtained by this method.

The present invention relates to a novel method for preparing starch-based thermoplastic compositions and the compositions thus obtained.

The expression “thermoplastic composition” is understood within the present invention to mean a composition which, reversibly, softens under the action of heat and hardens by cooling. It has at least one glass transition temperature (T_{g}) below which the amorphous fraction of the composition is in the brittle glassy state, and above which the composition may undergo reversible plastic deformations. The glass transition temperature or at least one of the glass transition temperatures of the starch-based thermoplastic composition of the present invention is preferably between −50° C. and 150° C. This starch-based composition may, of course, be formed by processes conventionally used in plastics processing (extrusion, injection molding, molding, blow molding, calendering, etc.). Its viscosity, measured at a temperature of 100° C. to 200° C., is generally between 10 and 10⁶ Pa·s.

Preferably, said composition is “thermofusible”, that is to say that it can be formed without application of high shear forces, that is to say by simple flowing or simple pressing of the molten material. Its viscosity, measured at a temperature of 100° C. to 200° C., is generally between 10 and 10³ Pa·s.

In the current context of climate changes due to the greenhouse effect and to global warming, of the upward trend in the costs of fossil raw materials, in particular of oil from which plastics are derived, of the state of public opinion in search of sustainable development, more natural, cleaner, healthier and more energy-efficient products, and of the change in regulations and taxations, it is necessary to provide novel compositions derived from renewable resources, which are suitable, in particular, for the field of plastics, and which are simultaneously competitive, designed from the outset to have only few or no negative impacts on the environment, and technically as high-performance as the polymers prepared from raw materials of fossil origin.

Starch constitutes a raw material that has the advantages of being renewable, biodegradable and available in large amounts at an economically advantageous price compared to oil and gas, used as raw materials for current plastics.

The biodegradable nature of starch has already been exploited in the manufacture of plastics, in accordance with two main technical solutions.

The first starch-based compositions were developed around thirty years ago. The starches were then used in the form of mixtures with synthetic polymers such as polyethylene, as filler, in the native granular form. Before dispersion in the synthetic polymer constituting the matrix, or continuous phase, the native starch is preferably dried to a moisture content of less than 1% by weight, in order to reduce its hydrophilic nature. For this same purpose, it may also be coated with fatty substances (fatty acids, silicones, siliconates) or else be modified at the surface of the grains with siloxanes or isocyanates.

The materials thus obtained generally contained around 10%, at the very most 20% by weight of granular starch, because beyond this value, the mechanical properties of the composite materials obtained became too imperfect and reduced compared to those of the synthetic polymers forming the matrix. Furthermore, it appeared that such polyethylene-based compositions were only biofragmentable and not biodegradable as anticipated, so that the expected boom of these compositions did not take place. In order to overcome the lack of biodegradability, developments were also subsequently carried out along the same principle but by only replacing the conventional polyethylene with oxidation-degradable polyethylenes or with biodegradable polyesters such as polyhydroxybutyrate-co-hydroxyvalerate (PHBV) or polylactic acid (PLA). Here too, the mechanical properties of such composites, obtained by mixing with granular starch, proved to be insufficient. Reference may be made, if necessary, to the excellent book “La Chimie Verte” [Green Chemistry], Paul Colonna, Editions TEC & DOC, January 2006, chapter entitled “Matériaux à base d'amidons et de leurs dérivés” [Materials based on starches and on their derivatives] by Denis Lourdin and Paul Colonna, pages 161 to 166.

Subsequently, starch was used in an essentially amorphous and thermoplastic state. This state is obtained by plasticization of the starch with the aid of a suitable plasticizer incorporated into the starch in an amount generally between 15 and 25% relative to the granular starch, by supplying mechanical and thermal energy. The U.S. Pat. No. 5,095,054 by Warner Lambert and EP 0 497 706 B1 by the applicant describe, in particular, this destructured state, having reduced or absent crystallinity, and means for obtaining such thermoplastic starches.

However, the mechanical properties of the thermoplastic starches, although they can be adjusted to a certain extent by the choice of the starch, of the plasticizer and of the usage level of the latter, are overall quite mediocre since the materials thus obtained are still very highly viscous at high temperature (120° C. to 170° C.) and very frangible, too brittle and very hard at low temperature, that is to say below the glass transition temperature or below the highest glass transition temperature.

Thus, the elongation at break of such thermoplastic starches is very low, always below around 10%, even with a very high plasticizer content of the order of 30%. By way of comparison, the elongation at break of low-density polyethylenes is generally between 100 and 1000%.

Furthermore, the maximum tensile strength of thermoplastic starches decreases very greatly when the level of plasticizer increases. It has an acceptable value, of the order of 15 to 60 MPa, for a plasticizer content of 10 to 25%, but reduces in an unacceptable manner above 30%.

Therefore, these thermoplastic starches have been the subject of numerous research studies aiming to develop biodegradable and/or water-soluble formulations having better mechanical properties by physical mixing of these thermoplastic starches, either with polymers of oil origin such as polyvinyl acetate (PVA), polyvinyl alcohols (PVOHs), ethylene/vinyl alcohol copolymers (EVOHs), biodegradable polyesters such as polycaprolactones (PCLs), polybutylene adipate terephthalates (PBATs) and polybutylene succinate adipates (PBSs), or with polyesters of renewable origin such as polylactic acids (PLAs) or microbial polyhydroxyalkanoates (PHA, PHB and PHBV), or else with natural polymers extracted from plants or from animal tissues. Reference may again be made to the book “La Chimie Verte” [Green Chemistry], Paul Colonna, Editions TEC & DOC, pages 161 to 166, but also, for example, to patents EP 0 579 546 B1, EP 0 735 104 B1 and FR 2 697 259 by the applicant which describe compositions containing thermoplastic starches.

Under a microscope, these resins appear to be very heterogeneous and have small islands of plasticized starch in a continuous phase of synthetic polymers. This is due to the fact that the thermoplastic starches are very hydrophilic and are consequently not very compatible with the synthetic polymers. It results therefrom that the mechanical properties of such mixtures, even with addition of compatibilizing agents such as, for example, copolymers comprising hydrophobic units and hydrophilic units alternately, such as ethylene/acrylic acid copolymers (EAAs), or else cyclodextrins or organosilanes, remain quite limited.

By way of example, the commercial product MATER-BI of Y grade has, according to the information given by its manufacturer, an elongation at break of 27% and a maximum tensile strength of 26 MPa. Consequently, these composites today find restricted uses, that is to say uses limited essentially to the sole sectors of overwrapping, garbage bags, checkout bags and bags for certain rigid bulky objects that are biodegradable.

The destructuring of the semicrystalline native granular state of the starch in order to obtain thermoplastic amorphous starches can be carried out in a barely hydrated medium via extrusion processes. Obtaining a molten phase from starch granules requires not only a large supply of mechanical energy and of thermal energy but also the presence of a plasticizer or else risks carbonizing the starch. Water is the most natural plasticizer of starch and is consequently commonly used, but other molecules are also very effective, especially sugars such as glucose, maltose, fructose or saccharose; polyols such as ethylene glycol, propylene glycol, polyethylene glycols (PEGs), glycerol, sorbitol, xylitol, maltitol or hydrogenated glucose syrups; urea, salts of organic acids such as sodium lactate and also mixtures of these products.

The amount of energy to be applied in order to plasticize the starch may advantageously be reduced by increasing the amount of plasticizer. In practice, the use of a plasticizer at a high level compared to the starch induces, however, various technical problems, among which mention may be made of the following:
a release of the plasticizer from the plasticized matrix from the end of the manufacture or during the storage time, so that it is impossible to retain an amount of plasticizer that is as high as desired and consequently to obtain a sufficiently flexible and film-forming material;
great instability of the mechanical properties of the plasticized starch which cures or softens as a function of the atmospheric moisture, respectively when its water content decreases or increases;
the whitening or opacification of the surface of the composition by crystallization of the plasticizer used at high dose, such as for example in the case of xylitol;
a tacky or oily nature of the surface, as in the case of glycerol for example;
a very poor water resistance, even more problematic when the plasticizer content is high. A loss of physical integrity is observed in water, so that the plasticized starch cannot, at the end of manufacture, be cooled by immersion in a bath of water as for conventional polymers. Therefore, its uses are very limited. In order to extend its usage possibilities, it is necessary to mix it with large amounts, generally greater than or equal to 60%, of polyesters or of other expensive polymers; and
a possible premature hydrolysis of the polyesters (PLA, PBAT, PCL, PET) optionally associated with the thermoplastic starch.

The present invention provides an effective solution to the problems mentioned above.

One subject of the present invention is a method for preparing a starch-based thermoplastic composition comprising the following steps:
(a) selection of at least one granular starch (component 1) and of at least one organic plasticizer (component 2) of this starch;
(b) preparation of a plasticized composition by thermomechanical mixing of this starch and of this organic plasticizer;
(c) optional incorporation, into the plasticized composition obtained in step (b), of at least one functional substance (optional component 4), other than granular starch, bearing functional groups having an active hydrogen and/or functional groups which give, via hydrolysis, such functional groups having an active hydrogen; and
(d) incorporation, into the plasticized composition obtained, of at least one coupling agent (component 3) bearing at least two functional groups capable of reacting with molecules bearing functional groups having an active hydrogen and capable of enabling the attachment, via covalent bonds, of at least one part of the plasticizer to the starch and/or to the functional substance optionally added in step (c), said coupling agent having a molecular weight of less than 5000, and being chosen from diacids and compounds bearing at least two identical or different, free or masked functional groups chosen from isocyanate, carbamoylcaprolactam, epoxide, halogen, acid anhydride, acyl halide, oxychloride, trimetaphosphate and alkoxysilane functional groups.

Within the meaning of the invention, the expression “granular starch” is understood to mean a native starch or a physically, chemically or enzymatically modified starch that has retained, within the starch granules, a semicrystalline structure similar to that displayed in the starch grains naturally present in the reserve tissues and organs of higher plants, in particular in the seeds of cereal plants, the seeds of leguminous plants, potato or cassava tubers, roots, bulbs, stems and fruits. This semicrystalline state is essentially due to the macromolecules of amylopectin, one of the two main constituents of starch. In the native state, the starch grains have a degree of crystallinity which varies from 15 to 45%, and which essentially depends on the botanical origin of the starch and on the optional treatment that it has undergone. Granular starch, placed under polarized light, has a characteristic black cross known as a Maltese cross, typical of the granular state. For a more detailed description of granular starch, reference could be made to chapter II entitled “Structure et morphologie du grain d'amidon” [Structure and morphology of the starch grain] by S. Perez, in the work “Initiation à la chimie et à la physico-chimie macromoléculaires” [Introduction to macromolecular chemistry and physical chemistry], first edition 2000, Volume 13, pages 41 to 86, Groupe Français d'Etudes et d'Application des Polymères [French Group of Polymer Studies and Applications].

The expression “plasticizer of the starch” is understood to mean any organic molecule of low molecular weight, that is to say preferably having a molecular weight of less than 5000, in particular less than 1000, which, when it is incorporated into the starch via a thermomechanical treatment at a temperature between 20 and 200° C., results in a decrease of the glass transition temperature and/or a reduction of the crystallinity of a granular starch to a value of less than 15%, or even to an essentially amorphous state. This definition of the plasticizer does not encompass water, which, although it has a starch-plasticizing effect, has the major drawback of inactivating most of the functional groups capable of being present on the crosslinking agent, such as the epoxide isocyanate functional groups.

The expression “functional substance” is understood to mean any molecule, other than the granular starch, the coupling agent and the plasticizer, bearing functional groups having an active hydrogen, that is to say functional groups having at least one hydrogen atom capable of being displaced if a chemical reaction takes place between the atom bearing this hydrogen atom and another reactive functional group. Functional groups having an active hydrogen are, for example, hydroxyl, protonic acid, urea, urethane, amide, amine or thiol functional groups. This definition also encompasses, in the present invention, any molecule, other than the granular starch, the coupling agent and the plasticizer, bearing functional groups capable of giving, especially via hydrolysis, such functional groups having an active hydrogen. The functional groups that can give such functional groups having an active hydrogen are, for example, alkoxy functional groups, in particular alkoxysilanes, or acyl chloride, acid anhydride, epoxide or ester functional groups.

The functional substance is preferably an organic oligomer or polymer having a weight-average molecular weight between 5000 and 5 000 000, especially between 8500 and 3 000 000, in particular between 15 000 and 1 000 000 daltons.

The expression “coupling agent” is understood to mean any molecule bearing at least two free or masked functional groups capable of reacting with molecules bearing functional groups having an active hydrogen such as in particular the plasticizer of the starch. This coupling agent therefore enables the attachment, via covalent bonds, of at least one part of the plasticizer to the starch and/or to the functional substance. This coupling agent differs from adhesion agents, physical compatibilizing agents or grafting agents by the fact that the latter either only create weak bonds (non-covalent bonds), or only bear a single reactive functional group.

The molecular weight of the coupling agent is preferably less than 5000 and most particularly less than 1000. Indeed, the low molecular weight of the coupling agent favors its rapid and easy incorporation into the starch composition plasticized by the plasticizer.

Preferably, said coupling agent has a molecular weight between 50 and 500, in particular between 90 and 300.

Preferably, the method comprises the step (c) of incorporating at least one functional substance into the thermoplastic composition containing the starch and the plasticizer. In this case, that is to say when a functional substance is introduced, the coupling agent used is preferably chosen so that one of its reactive functional groups is capable of reacting with the reactive functional groups of this functional substance. This makes it possible to at least partially attach the plasticizer, via covalent bonding, to the functional substance. The plasticizer can therefore be at least partly attached either to the starch or to the functional substance or else to both of these two components.

The method of the present invention preferably also comprises a step (e) of heating of the mixture obtained in step (d) to a sufficient temperature in order to react the coupling agent, on the one hand, with the plasticizer and, on the other hand, with the starch and/or the functional substance optionally present. Steps (d) and (e) may be carried out simultaneously or else one after the other after a very variable time.

The incorporation of the coupling agent into the thermoplastic composition and the reaction with the starch and/or the functional substance (steps (c) and (d)) is preferably carried out by hot kneading at a temperature between 60 and 200° C., and better still between 100 and 160° C.

The coupling agent may be chosen, for example, from compounds bearing at least two identical or different, free or masked, functional groups, chosen from isocyanate, carbamoylcaprolactam, epoxide, halogen, acid anhydride, acyl halide, oxychloride, trimetaphosphate, and alkoxysilane functional groups.

The coupling agent may also be an organic diacid.

It may advantageously be the following compounds:
diisocyanates and polyisocyanates, preferably 4,4′-dicyclohexylmethane diisocyanate (H12MDI), methylene diphenyl diisocyanate (MDI), toluene diisocyanate (TDI), naphthalene diisocyanate (NDI), hexamethylene diisocyanate (HMDI) and lysine diisocyanate (LDI);
dicarbamoylcaprolactams, preferably 1,1′-carbonylbiscaprolactam;
diepoxides;
halohydrins, that is to say compounds comprising an epoxide functional group and a halogen functional group, preferably epichlorohydrin;
organic diacids, preferably succinic acid, adipic acid, glutaric acid, oxalic acid, malonic acid, maleic acid and the corresponding anhydrides;
oxychlorides, preferably phosphorus oxychloride;
trimetaphosphates, preferably sodium trimetaphosphate;
alkoxysilanes, preferably tetraethoxysilane,
   and any mixtures of these compounds.

In one preferred embodiment of the method of the invention, the coupling agent is chosen from diepoxides, diisocyanates and halohydrins. In particular, it is preferred to use a coupling agent chosen from diisocyanates, methylene diphenyl diisocyanate (MDI) and 4,4′-dicyclohexylmethane diisocyanate (H12MDI) being particularly preferred.

The appropriate amount of coupling agent depends, in particular, on the plasticizer content. It has surprisingly and unexpectedly been noted that the higher the amount of plasticizer introduced, the more the amount of coupling agent can be increased without the final material becoming hard and losing its thermoplastic properties.

The amount of coupling agent used is preferably between 0.01 and 15 parts, in particular between 0.1 and 12 parts and better still between 0.1 and 9 parts per 100 parts of plasticized composition from step (b), optionally containing the functional substance.

By way of example, this amount of coupling agent may be between 0.5 and 5 parts, in particular between 0.5 and 3 parts, per 100 parts by weight of plasticized composition from step (b), optionally containing the functional substance.

Against all expectation, very small amounts of coupling agent considerably reduce the sensitivity to water and to steam of the final thermoplastic composition obtained according to the invention and therefore make it possible, in particular, to cool this composition rapidly at the end of manufacture by immersion in water, which is not the case for a plasticized starch prepared by simple mixing with the plasticizer, that is to say without the use of a coupling agent capable of bonding the plasticizer to the starch or to the functional substance optionally introduced. It was also observed that the starch-based thermoplastic compositions prepared according to the method claimed exhibited less thermal degradation and less coloration than the plasticized starches of the prior art. The latter, due to their high sensitivity to water, must moreover necessarily be cooled in air, which requires much more time than cooling in water. Furthermore, this characteristic of stability to water opens up many new potential uses for the composition according to the invention.

The article entitled “Effect of Compatibilizer Distribution on the Blends of Starch/Biodegradable Polyesters” by Long Yu et al., Journal of Applied Polymer Science, Vol. 103, 812-818 (2007), 2006, Wiley Periodicals Inc., describes the effect of methylene diphenyl diisocyanate (MDI) as a compatibilizing agent of mixtures of a starch gelatinized with water (70% starch, 30% water) and of a biodegradable polyester (PCL or PBSA), which are known for being immiscible with one another from a thermodynamic viewpoint. This document does not at any moment envisage the use of an organic plasticizer, capable of replacing the water which has the drawbacks, observed by the Applicant, of deactivating the isocyanate functional groups of MDI used and of not allowing a thermoplastic starchy composition of sufficient flexibility to be obtained, probably due to the evaporation of the water on exiting the thermomechanical treatment device or during storage.

The article entitled “Effects of Starch Moisture on Properties on Wheat Starch/Poly(Lactic Acid) Blend Containing Methylenediphenyl Diisocyanate”, by Wang et al., published in Journal of Polymers and the Environment, Vol. 10, No. 4, October 2002, also relates to the compatibilization of a starch solution and of a polylactic acid (PLA) phase by the addition of methylene diphenyl isocyanate (MDI). As in the preceding article, water is the only plasticizer envisaged but has the drawbacks pointed out previously.

The article entitled “Thermal and Mechanical Properties of Poly(lactic acid)/Starch/Methylenediphenyl Diisocyanate Blending with Triethyl Citrate” by Ke et al., Journal of Applied Polymer Science, Vol. 88, 2947-2955 (2003) relates, like the above two articles, to the problem of the thermodynamic incompatibility of starch and PLA. This document studies the effect of the use of triethyl citrate, as a plasticizer in starch/PLA/MDI mixtures. However, it clearly emerges from this document (see page 2952, left-hand column, Morphology) that triethyl citrate plays the role of plasticizer only for the PLA phase but not for the starchy phase which remains in the form of starch granules dispersed in a PLA matrix plasticized by the triethyl citrate.

International Application WO 01/48078 describes a method for preparing thermoplastics by incorporating a synthetic polymer in the melt state into thermoplastic compositions. This document envisages, certainly, the use of a plasticizer of polyol type, but does not at any moment mention the possibility of attaching the plasticizer to the starch and/or the synthetic polymer via a low molecular weight bifunctional coupling agent.

The article entitled “The influence of citric acid on the properties of thermoplastic starch/linear low-density polyethylene blends” by Ning et al., in Carbohydrate Polymers, 67, (2007), 446-453 studies the effect of the presence of citric acid on thermoplastic starch/polyethylene mixtures. This document does not at any moment envisage the attachment of the plasticizer used (glycerol) to the starch via a bifunctional or polyfunctional compound. The spectroscopy results do not display any covalent bond between the citric acid and the starch or the polyethylene. It is simply observed that the physical bonds (hydrogen bonds) between the starch and the glycerol are strengthened by the presence of citric acid.

In conclusion, none of the above documents describes nor suggests a method similar to that of the present invention comprising the incorporation of a reactive, at least bifunctional, coupling agent as claimed into a plasticized composition based on starch and a plasticizer of the starch, and the bonding of the plasticizer to the starch and/or to a functional substance by means of the bifunctional coupling agent as claimed.

According to the invention, the granular starch may come from any botanical origin. It may be native starch of cereal plants such as wheat, maize, barley, triticale, sorghum or rice, tubers such as potato or cassava, or leguminous plants such as pea or soybean, and mixtures of such starches. According to one preferred variant, the granular starch is a starch hydrolyzed by an acid, oxidizing or enzymatic route, or an oxidized starch. It may be, in particular, a starch commonly known as fluidized starch or a white dextrin. It may also be a starch modified by a physicochemical route, but that has essentially retained the structure of the initial native starch, such as, in particular, esterified and/or etherified starches, in particular that are modified by acetylation, hydroxypropylation, cationization, crosslinking, phosphation or succinylation, or starches treated in an aqueous medium at low temperature (“annealed” starches), treatment which is known to increase the crystallinity of the starch. Preferably, the granular starch is a hydrolyzed, oxidized or modified, native wheat or pea starch.

The granular starch generally has a solubles content at 20° C. in demineralized water of less than 5% by weight. It is preferably almost insoluble in cold water.

The plasticizer of the starch is preferably chosen from diols, triols and polyols such as glycerol, polyglycerol, isosorbide, sorbitans, sorbitol, mannitol, and hydrogenated glucose syrups, the salts of organic acids such as sodium lactate, urea and mixtures of these products. The plasticizer advantageously has a molecular weight of less than 5000, preferably less than 1000, and in particular less than 400. The organic plasticizer has of course a molecular weight greater than 18, in other words, it does not include water.

Owing to the presence of the coupling agent, the amount of plasticizer used in the present invention may advantageously be relatively high compared to the amount of plasticizer used in the plasticized starches of the prior art. The plasticizer is incorporated into the granular starch preferably in an amount of 10 to 150 parts by weight, preferably in an amount of 25 to 120 parts by weight and in particular in an amount of 40 to 120 parts by weight per 100 parts by weight of starch.

The functional substance bearing functional groups having an active hydrogen and/or functional groups capable of giving, especially via hydrolysis, such functional groups having an active hydrogen may be a polymer of natural origin, or else a synthetic polymer obtained from monomers of fossil origin and/or monomers derived from renewable natural resources.

The polymers of natural origin may be obtained by extraction from plants or animal tissues. They are preferably modified or functionalized, and are in particular of protein, cellulose, lignocellulose, chitosan and natural rubber type.

It is also possible to use polymers obtained by extraction from cells of microorganisms, such as polyhydroxyalkanoates (PHAs).

Such a polymer of natural origin may be chosen from flours, modified or unmodified proteins, celluloses that are unmodified or that are modified, for example, by carboxymethylation, ethoxylation, hydroxypropylation, cationization, acetylation or alkylation, hemi-celluloses, lignins, modified or unmodified guars, chitins and chitosans, natural resins and gums such as natural rubbers, rosins, shellacs and terpene resins, polysaccharides extracted from algae such as alginates and carrageenans, polysaccharides of bacterial origin such as xanthans or PHAs, lignocellulosic fibers such as flax fibers.

The synthetic polymer obtained from monomers of fossil origin, preferably comprising functional groups having active hydrogen, may be chosen from synthetic polymers of polyester, polyacrylic, polyacetal, polycarbonate, polyamide, polyimide, polyurethane, polyolefin, functionalized polyolefin, styrene, functionalized styrene, vinyl, functionalized vinyl, functionalized fluoro, functionalized polysulfone, functionalized polyphenyl ether, functionalized polyphenyl sulfide, functionalized silicone and functionalized polyether type.

By way of example, mention may be made of PLAs, PBSs, PBSAs, PBATs, PETs, polyamides PA-6, PA-6,6, PA-6,10, PA-6,12, PA-11 and PA-12, copolyamides, polyacrylates, polyvinyl alcohol, polyvinyl acetates, ethylene/vinyl acetate copolymers (EVAs), ethylene/methyl acrylate copolymers (EMAs), ethylene/vinyl alcohol copolymers (EVOHs), polyoxymethylenes (POMs), acrylonitrile-styrene-acrylate copolymers (ASAs), thermoplastic polyurethanes (TPUs), polyethylenes or polypropylenes that are functionalized, for example, by silane, acrylic or maleic anhydride units and styrene-butylene-styrene (SBS) and styrene-ethylene-butylene-styrene (SEBS) copolymers, preferably functionalized, for example, with maleic anhydride units and any mixtures of these polymers.

The polymer used as a functional substance may also be a polymer synthesized from monomers derived from short-term renewable natural resources such as plants, microorganisms or gases, especially from sugars, glycerol, oils or derivatives thereof such as alcohols or acids, which are monofunctional, difunctional or polyfunctional, and in particular from molecules such as bio-ethanol, bio-ethylene glycol, bio-propanediol, biosourced 1,3-propanediol, bio-butanediol, lactic acid, biosourced succinic acid, glycerol, isosorbide, sorbitol, saccharose, diols derived from plant oils or animal oils and resinic acids extracted from pine.

It may especially be polyethylene derived from bio-ethanol, polypropylene derived from bio-propanediol, polyesters of PLA or PBS type based on biosourced lactic acid or succinic acid, polyesters of PBAT type based on biosourced butanediol or succinic acid, polyesters of SORONA® type based on biosourced 1,3-propanediol, polycarbonates containing isosorbide, polyethylene glycols based on bio-ethylene glycol, polyamides based on castor oil or on plant polyols, and polyurethanes based, for example, on plant diols, glycerol, isosorbide, sorbitol or saccharose.

Preferably, the non-starchy polymer is chosen from ethylene/vinyl acetate copolymers (EVAs), polyethylenes (PEs) and polypropylenes (PPs) that are unfunctionalized or functionalized, in particular, with silane units, acrylic units or maleic anhydride units, thermoplastic polyurethanes (TPUs), polybutylene succinates (PBSs), polybutylene succinate-co-adipates (PBSAs), polybutylene adipate terephthalates (PBATs), styrene-butylene-styrene and styrene-ethylene-butylene-styrene (SEBSs) copolymers, preferably that are functionalized, in particular with maleic anhydride units, amorphous polyethylene terephthalates (PETGs), synthetic polymers obtained from biosourced monomers, polymers extracted from plants, from animal tissues and from microorganisms, which are optionally functionalized, and mixtures thereof.

Mention may be made, as examples of particularly preferred non-starchy polymers, of polyethylenes (PEs) and polypropylenes (PPs), preferably that are functionalized, styrene-ethylene-butylene-styrene copolymers (SEBSs), preferably that are functionalized, amorphous polyethylene terephthalates (PETGs) and thermoplastic polyurethanes.

Advantageously, the non-starchy polymer has a weight-average molecular weight between 8500 and 10 000 000 daltons, in particular between 15 000 and 1 000 000 daltons.

Furthermore, the non-starchy polymer is preferably constituted of carbon of renewable origin within the meaning of ASTM D6852 standard and is advantageously not biodegradable or not compostable within the meaning of the EN 13432, ASTM D6400 and ASTM 6868 standards.

In one preferred embodiment of the method of the invention, the plasticized composition of step (b), optionally containing a functional substance (optional component 4), is dried or dehydrated, before the incorporation of the coupling agent (component 3) in step (d), to a residual moisture content of less than 5%, preferably less than 1%, and in particular less than 0.1%.

Depending on the amount of water to be eliminated, this drying or dehydration step may be carried out in batches or continuously during the method.

Preferably, the thermomechanical mixing of the native starch and the plasticizer is carried out by hot kneading at a temperature preferably between 60 and 200° C., more preferably between 100 and 160° C., in a batchwise manner, for example by dough mixing/kneading, or continuously, for example by extrusion. The duration of this mixing may range from a few seconds to a few hours, depending on the mixing method used.

Similarly, the incorporation, during step (d), of the coupling agent into the plasticized composition may be carried out by hot kneading at a temperature between 60 and 200° C., and better still from 100 to 160° C. This incorporation may be carried out by thermomechanical mixing, in a batchwise manner or continuously and in particular in-line, by reactive extrusion. In this case, the mixing time may be short, from a few seconds to a few minutes.

Another subject of the present invention is a thermoplastic starch-based composition capable of being obtained by the method of the invention.

The composition in accordance with the invention is thermoplastic within the meaning defined above and therefore advantageously has a complex viscosity, measured on a rheometer of PHYSICA MCR 501 type or equivalent, between 10 and 10⁶ Pa·s, for a temperature between 100 and 200° C. For injection molding uses, for example, its viscosity at these temperatures may be rather low and the composition is then preferably thermofusible within the meaning specified above.

This composition is either a simple mixture of the three or four components (starch, plasticizer, coupling agent, optional functional substance), or a mixture comprising macromolecular products resulting from the reaction of the coupling agent with each of the two or three other components. In other words, a subject of the present invention is not only the composition obtained at the end of step (e), but also that obtained at the end of step (d), that is to say before reaction, in step (e), of the coupling agent with the other components.

Of course, the advantageous properties of the thermoplastic compositions of the present invention are those of the compositions, resulting from step (e), which have undergone the step of reaction of the coupling agent.

When the compositions of the present invention contain a functional substance, they preferably have a structure of “solid dispersion” type. In other words, the compositions of the present invention contain the plasticized starch in the form of domains dispersed in a continuous functional substance matrix. This dispersion-type structure should be distinguished, in particular, from a structure where the plasticized starch and the functional substance constitute just one and the same phase, or else compositions containing two co-continuous networks of plasticized starch and of functional substance. The objective of the present invention is not in fact to prepare materials that are above all biodegradable, but plastics with a high starch content that have excellent rheological and mechanical properties.

For this same reason, the functional substance is preferably chosen from synthetic polymers that are not biodegradable within the meaning of the EN 13432, ASTM D6400 and ASTM 6868 standards.

The thermoplastic compositions according to the invention have the advantage of being not very soluble or even completely insoluble in water, of hydrating with difficulty and of retaining good physical integrity after immersion in water. Their insolubles content in water at 20° C. is preferably greater than 72%, in particular greater than 80%, better still greater than 90%. Very advantageously, it may be greater than 92%, especially greater than 95%. Ideally, this insolubles content may be at least equal to 98% and especially be close to 100%.

Furthermore, the degree of swelling of the thermoplastic compositions according to the invention, after immersion in water at 20° C. for a duration of 24 hours, is preferably less than 20%, in particular less than 12%, better still less than 6%. Very advantageously, it may be less than 5%, especially less than 3%. Ideally, this degree of swelling is at most equal to 2% and may especially be close to 0%.

Unlike the compositions of the prior art with high contents of thermoplastic starch, the composition according to the invention advantageously has stress/strain curves that are characteristic of a ductile material, and not of a brittle material. The elongation at break, measured for the compositions of the present invention, is greater than 40%, preferably greater than 80%, better still greater than 90%. This elongation at break may advantageously be at least equal to 95%, especially at least equal to 120%. It may even attain or exceed 180%, or even 250%. In general, it is reasonably below 500%.

The maximum tensile strength of the compositions of the present invention is generally greater than 4 MPa, preferably greater than 6 MPa, better still greater than 8 MPa. It may even attain or exceed 10 MPa, or even 20 MPa. In general, it is reasonably below 80 MPa.

In one embodiment, the thermoplastic composition of the present invention contains a functional substance as described above. This functional substance is preferably a polymer chosen from functionalized polyethylenes (PEs) and polypropylenes (PPs), functionalized styrene-ethylene-butylene-styrene copolymers (SEBSs), amorphous polyethylene terephthalates and thermoplastic polyurethanes (TPUs).

The composition according to the invention may also comprise various other additional products. These may be products that aim to improve its physicochemical properties, in particular its processing behavior and its durability or else its mechanical, thermal, conductive, adhesive or organoleptic properties.

The additional product may be an agent that improves or adjusts mechanical or thermal properties chosen from minerals, salts and organic substances, in particular from nucleating agents such as talc, compatibilizing agents such as surfactants, agents that improve the impact strength or scratch resistance such as calcium silicate, shrinkage control agents such as magnesium silicate, agents that trap or deactivate water, acids, catalysts, metals, oxygen, infrared radiation or UV radiation, hydrophobic agents such as oils and fats, hygroscopic agents such as pentaerythritol, flame retardants and fire retardants such as halogenated derivatives, anti-smoke agents, mineral or organic reinforcing fillers, such as clays, carbon black, talc, plant fibers, glass fibers or kevlar.

The additional product may also be an agent that improves or adjusts conductive or insulating properties with respect to electricity or heat, impermeability for example to air, water, gases, solvents, fatty substances, gasolines, aromas and fragrances, chosen, in particular, from minerals, salts and organic substances, in particular from nucleating agents such as talc, compatibilizing agents such as surfactants, agents which trap or deactivate water, acids, catalysts, metals, oxygen or infrared radiation, hydrophobic agents such as oils and fats, beading agents, hygroscopic agents such as pentaerythritol, agents for conducting or dissipating heat such as metallic powders, graphites and salts, and micrometric reinforcing fillers such as clays and carbon black.

The additional product may also be an agent that improves organoleptic properties, in particular:
odorant properties (fragrances or odor-masking agents);
optical properties (brighteners, whiteners, such as titanium dioxide, dyes, pigments, dye enhancers, opacifiers, mattifying agents such as calcium carbonate, thermochromic agents, phosphorescence and fluorescence agents, metallizing or marbling agents and antifogging agents);
sound properties (barium sulfate and barytes); and
tactile properties (fatty substances).

The additional product may also be an agent that improves or adjusts adhesive properties, especially adhesion with respect to cellulose materials such as paper or wood, metallic materials such as aluminum and steel, glass or ceramic materials, textile materials and mineral materials, especially pine resins, rosin, ethylene/vinyl alcohol copolymers, fatty amines, lubricants, demolding agents, antistatic agents and antiblocking agents.

Finally, the additional product may be an agent that improves the durability of the material or an agent that controls its (bio)degradability, especially chosen from hydrophobic agents such as oils and fats, anticorrosion agents, antimicrobial agents such as Ag, Cu and Zn, degradation catalysts such as oxo catalysts and enzymes such as amylases.

The thermoplastic composition of the present invention also has the advantage of being constituted of essentially renewable raw materials and of being able to exhibit, after adjustment of the formulation, the following properties, that are of use in multiple plastics processing applications or in other fields:
suitable thermoplasticity, melt viscosity and glass transition temperature, within the standard value ranges known for common polymers (T_{g} of from −50° to 150° C.), allowing implementation by virtue of existing industrial installations that are conventionally used for standard synthetic polymers;
sufficient miscibility with a wide variety of polymers of fossil origin or of renewable origin that are on the market or in development;
satisfactory physicochemical stability for the usage conditions;
low sensitivity to water and to steam;
mechanical performances that are very significantly improved compared to the thermoplastic starch compositions of the prior art (flexibility, elongation at break, maximum tensile strength);
good barrier effect to water, to steam, to oxygen, to carbon dioxide, to UV radiation, to fatty substances, to aromas, to gasolines, to fuels;
opacity, translucency or transparency that can be adjusted as a function of the uses;
good printability and ability to be painted, especially by aqueous-phase inks and paints;
controllable shrinkage;
stability over sufficient time; and
adjustable biodegradability, compostability and/or recyclability.

Quite remarkably, the thermoplastic starch-based composition of the present invention may, in particular, simultaneously have:
an insolubles content at least equal to 98%;
a degree of swelling of less than 5%;
an elongation at break at least equal to 95%; and
a maximum tensile strength of greater than 8 MPa.

The thermoplastic composition according to the invention may be used as is or as a blend with synthetic polymers, artificial polymers or polymers of natural origin. It may be biodegradable or compostable within the meaning of the EN 13432, ASTM D6400 and ASTM 6868 standards, and then comprise polymers or materials corresponding to these standards, such as PLA, PCL, PBSA, PBAT and PHA.

It may in particular make it possible to correct certain major defects that are known for PLA, namely:
the mediocre barrier effect to CO₂ and to oxygen;
the inadequate barrier effects to water and to steam;
the inadequate heat resistance for the manufacture of bottles and the very inadequate heat resistance for the use as textile fibers; and
a brittleness and lack of flexibility in the form of films.

The composition according to the invention is however preferably not biodegradable or not compostable within the meaning of the above standards, and then comprises, for example, known synthetic polymers or starches or extracted polymers that are highly functionalized, crosslinked or etherified. The best performances in terms of rheological, mechanical and water-insensitivity properties have in fact been obtained with such non-biodegradable and non-compostable compositions.

It is possible to adjust the service life and the stability of the composition in accordance with the invention by adjusting, in particular, its affinity for water, so as to be suitable for the expected uses as material and for the methods of reuse envisaged at the end of life.

The composition according to the invention advantageously contain at least 33%, preferably at least 50%, in particular at least 60%, better still at least 70%, or even more than 80% of carbon of renewable origin within the meaning of ASTM D6852 standard. This carbon of renewable origin is essentially that constituent of the starch inevitably present in the composition according to the invention but may also advantageously, via a judicious choice of the constituents of the composition, be that present in the plasticizer of the starch as in the case, for example, of glycerol or sorbitol, but also of that present in the functional substance, any other functional product or any additional polymer, when they originate from renewable natural resources such as those preferentially defined above.

In particular, it can be envisaged to use the starch-based thermoplastic compositions according to the invention as barrier films to water, to steam, to oxygen, to carbon dioxide, to aromas, to fuels, to automotive fluids, to organic solvents and/or to fatty substances, alone or in multilayer or multiply structures, obtained by coextrusion, lamination or other techniques, for the field of packaging of printing supports, the insulation field or the textile field in particular.

The compositions of the present invention may also be used to increase the hydrophilic nature, the aptitude for electrical conduction or for microwaves, the printability, the ability to be dyed, to be colored in the bulk or to be painted, the antistatic or antidust effect, the scratch resistance, the fire resistance, the adhesive strength, the ability to be heat-welded, the sensory properties, in particular the feel and the acoustic properties, the water and/or steam permeability, or the resistance to organic solvents and/or fuels, of synthetic polymers within the context, for example, of the manufacture of membranes, of films for printable electronic labels, of textile fibers, of containers or tanks, or synthetic thermofusible films, of parts obtained by injection molding or extrusion such as automotive parts.

It should be noted that the relatively hydrophilic nature of the thermoplastic composition according to the invention considerably reduces the risks of bioaccumulation in the adipose tissues of living organisms and therefore also in the food chain.

The composition according to the invention may be in pulverulent form, granular form or in the form of beads and may constitute the matrix of a masterbatch that can be diluted in a biosourced or non-biosourced matrix.

The invention also relates to a plastic or elastomeric material comprising the thermoplastic composition of the present invention or a finished or semi-finished product obtained from this composition.

### EXAMPLE 1

### Comparison of Compositions Based on Wheat Starch According to the Invention with Compositions According to the Prior Art Prepared without Coupling Agent

Used for this example are:
a native wheat starch sold by the applicant under the name “Amidon de blé SP” [Wheat Starch SP] having a water content of around 12% (component 1);
a concentrated aqueous composition of polyols based on glycerol and on sorbitol, sold by the applicant under the name POLYSORB G84/41/00 having a water content of approximately 16% (component 2); and
methylene diphenyl diisocyanate (MDI) sold under the name Suprasec 1400 by Huntsman (component 3).

(a) Preparation of Base Thermoplastic (TPS) Compositions:

Firstly, a thermoplastic composition according to the prior art is prepared. For this, a twin-screw extruder of TSA brand having a diameter (D) of 26 mm and a length of 56D is fed with the starch and the plasticizer so as to obtain a total material throughput of 15 kg/h, by varying the ratio of the plasticizer (POLYSORB)/wheat starch mixture as follows:
100 parts/100 parts (composition AP5050)
67 parts/100 parts (composition AP6040)
54 parts/100 parts (composition AP6535)
43 parts/100 parts (composition AP7030)

The extrusion conditions are the following:
temperature profile (ten heating zones Z1 to Z10): 90/90/110/140/140/110/90/90/90/90;
screw speed: 200 rpm.

At the outlet of the extruder, it is observed that the materials thus obtained are too tacky at high plasticizer contents (Compositions AP5050 and AP6040) to be granulated in equipment commonly used with synthetic polymers. It is also observed that the compositions are still too water-sensitive to be cooled in a tank of cold water. For these reasons, the plasticized starch rods are cooled in air on a conveyor belt in order to then be dried at 80° C. in an oven under vacuum for 24 hours and then granulated.

(b) Preparation of Compositions According to the Invention (with MDI) and According to the Prior Art (without MDI)

Next, incorporated into the thermoplastic composition thus obtained in the form of granules, during a second pass through the extruder, are respectively 0, 1, 2, 4, 6, 8 and 12 parts of MDI per 100 parts of thermoplastic composition (phr).

On account of too great an increase in the viscosity, or even of crosslinking of the material in the extruder, and of an irreversible loss of the thermoplastic nature of the composition, it was impossible to incorporate:
more than 8 phr of MDI into the AP6040 composition;
more than 4 phr of MDI into the AP6535 composition;
and more than 2 phr of MDI into the AP7030 composition.

Water Stability Test:

The sensitivity to water and to moisture of the compositions prepared and the ability of the plasticizer to migrate to the water and to therefore induce a degradation of the structure of the material is evaluated.

The content of insolubles in water of the compositions obtained is determined according to the following protocol:
(i) drying the sample to be characterized (12 hours at 80° C. under vacuum);
(ii) measuring the mass of the sample (=Ms1) with a precision balance;
(iii) immersing the sample in water, at 20° C. (volume of water in ml equal to 100 times the mass in g of sample);
(iv) removing the sample after a defined time of several hours;
(v) removing the excess water at the surface with absorbent paper, as rapidly as possible;
(vi) placing the sample on a precision balance and monitoring the loss of mass over 2 minutes (measuring the mass every 20 seconds);
(vii) determining the mass of the swollen sample via graphical representation of the preceding measurements as a function of the time and extrapolation to t=0 of the mass (=Mg);
(viii) drying the sample (for 24 hours at 80° C. under vacuum). Measuring the mass of the dry sample (=Ms2);
(ix) calculating the insolubles content, expressed in percent, according to the equation Ms2/Ms1; and
(x) calculating the degree of swelling, in percent, according to the equation (Mg-Ms1)/Ms1.

Water Uptake Test:

The degree of moisture uptake is determined by measuring the mass of a sample of plasticized starch that has been stored for one month, before drying (Mₕ) and after drying under vacuum at 80° C. for 24 hours (Mₛ). The degree of moisture uptake corresponds to the difference (1-M_{S}/Mₕ) expressed in percent.

TABLE 1
Degree of moisture uptake and content of insolubles in
water of the plasticized starches with or without MDI

| | | | Content of |
|---|---|---|---|
| | | Degree of | insolubles (after |
| | MDI | moisture | immersion for |
| | incorporated | uptake | 1 h/3 h/24 h) |
| Composition | (phr) | (%) | (%) |
| AP5050 | 0* | 12.9 | 76.3/61.6/54.1 |
| | 4** | 7.8 | 81.8/72.3/58.1 |
| | 8** | 4.1 | 84.1/74.3/60.2 |
| | 12** | 3.9 | 85.5/76.0/61.0 |
| AP6040 | 0* | 5.8 | 86.3/74.1/63.7 |
| | 4** | 3.7 | 86.3/80.9/67.4 |
| | 6** | 5.5 | 91.8/84.7/67.7 |
| AP6535 | 0* | 10.9 | 86.0/78.1/68.9 |
| | 1** | 5.8 | 93.0/84.6/73.2 |
| | 2** | 5.4 | 96.4/88.7/76.5 |
| AP7030 | 0* | 3.9 | 90.8/85.2/71.4 |
| | 1** | 3.2 | 95.5/88.6/73.8 |

*according to the prior art
**according to the invention

Table 1 shows that the incorporation of MDI according to the invention simultaneously leads to a marked reduction in the degree of moisture uptake, a very marked reduction in the solubilisation kinetics and a significant increase in the content of insolubles in water.

These results imply that the plasticizer is bonded to the starch by virtue of the MDI, used as a coupling agent.

Analysis by mass spectrometry furthermore showed that the thermoplastic compositions thus prepared in accordance with the invention with use of a coupling agent such as MDI, contain specific entities of glucose-MDI-glycerol and glucose-MDI-sorbitol type, attesting to the attachment of the plasticizer to the starch via the coupling agent.

The compositions according to the invention prepared by reacting a coupling agent (MDI) with the thermoplastic starch-based compositions of the prior art are more stable to moisture and to water than the compositions of the prior art without MDI.

### EXAMPLE 2

### Addition of a Functional Substance

For the purpose of further increasing the water stability of the base thermoplastic starch mixture AP6040 obtained according to Example 1, MDI and a polyethylene grafted with 2% vinyltrimethoxysilane (PEgSi) are mixed with this composition thus forming a dry blend. The PEgSi used was obtained beforehand by grafting vinyltrimethoxysilane to a low-density PE by extrusion. As an example of such a PEgSi that is available on the market, mention may be made of the product BorPEX ME 2510 or BorPEX HE2515 both sold by Borealis.

The twin-screw extruder described previously is fed with this dry blend.

The extrusion conditions are the following:
temperature profile (ten heating zones Z1 to Z10): 150° C.;
screw speed: 400 rpm.

The following compositions are prepared by introducing various amounts of MDI: 0, 2 and 4 parts per 100 parts of thermoplastic composition AP6040 (phr).

The compositions prepared are listed in the table below.

TABLE 2
Compositions of silane-grafted PE/AP6040 blends
and water resistance results obtained

| | PEgSi/ | | Cooling | | |
|---|---|---|---|---|---|
| | AP6040 | MDI | with | Degree of | |
| Test | ratio | (phr) | water* | swelling** | Insolubles** |
| 07641 | 30/70 | 0 | 0 | broken up | not |
| | | | | | measurable |
| | | | | | (very low) |
| 07643 | 30/70 | 2 | 2 | 11 | 93 |
| 07644 | 10/90 | 4 | 1 | 35 | 60 |
| 07734 | 50/50 | 2 | 2 | 1.5 (2.7) | 100 (99.3) |
| 07735 | 40/60 | 2 | 2 | 3.5 (6.9) | 100 (98.0) |

*0 = impossible, 1 = possible, but sticky surface, 2 = possible without problem (hydrophobic)
**After 24 (72) hours in water at 20° C.

Measurement of the Mechanical Properties:

The mechanical properties in tension of the various samples are determined according to the NF T51-034 standard (determination of the tensile properties) using a Lloyd Instruments LR5K test bench, a pull rate of 50 mm/min and standardized test specimens of H2 type.

From tensile curves (stress=f(elongation)), obtained at a pull rate of 50 mm/min, the elongation at break and the corresponding maximum tensile strength are obtained for each of the silane-grafted PE/AP6040 blends.

TABLE 3

| | Elongation | Maximum tensile |
|---|---|---|
| Test | at break | strength |
| 07641 | 128% | 1.4 MPa |
| (comparative) | | |
| 07643 | 198% | 6.7 MPa |
| (invention) | | |
| 07644 | 245% | 4.5 MPa |
| (invention) | | |
| 07734 | 97% | 10.5 MPa |
| (invention) | | |
| 07735 | 123% | 8.3 MPa |
| (invention) | | |

The mixture 07641 containing 30% of silane-grafted PE, produced without MDI, is very hydrophilic and cannot consequently be cooled in water on exiting the die since it breaks up very rapidly via hydration in the cooling bath.

All the plasticized starch/PEgSi blends prepared with a coupling agent (MDI), even those containing less than 30% of PEgSi, are only slightly hydrophilic and can advantageously be cooled without difficulty in water.

Above 30%, the blends produced with MDI are very hydrophobic.

The mechanical properties of the compositions prepared with MDI are furthermore good to very good in terms of elongation at break and tensile strength.

The MDI, by bonding the plasticizer to the macromolecules of starch and of PEgSi, makes it possible to greatly improve the water resistance and mechanical strength properties, thus opening up multiple possible new uses for the compositions according to the invention compared to those of the prior art.

Moreover, observations by optical microscopy and scanning electron microscopy show that the compositions thus prepared according to the invention are in the form of dispersions of starch in a continuous polymer matrix of PEgSi.

All these blends have in particular good scratch resistance and a “leather” feel. They can therefore find, for example, an application as a coating for fabrics, for wood panels, for paper or board.

1. A method for preparing a starch-based thermoplastic composition comprising the following steps:
(a) selection of at least one granular starch (component 1) and of at least one organic plasticizer (component 2) of this starch;
(b) preparation of a plasticized composition by thermo-mechanical mixing of this starch and of this organic plasticizer;
(c) optional incorporation, into the plasticized composition obtained in step (b), of at least one functional substance (optional component 4), other than granular starch, bearing functional groups having an active hydrogen and/or functional groups which give, via hydrolysis, such functional groups having an active hydrogen; and
(d) incorporation, into the plasticized composition obtained, of at least one coupling agent (component 3) having a molecular weight of less than 5000, chosen from organic diacids and compounds bearing at least two identical or different, free or masked functional groups chosen from isocyanate, carbamoylcaprolactam, epoxide, halogen, acid anhydride, acyl halide, oxychloride, trimetaphosphate and alkoxysilane functional groups.

2. The method as claimed in claim 1, characterized by the fact that it also comprises a step (e) of heating of the mixture obtained in step (d) to a sufficient temperature in order to react the coupling agent, on the one hand, with the plasticizer and, on the other hand, with the starch and/or the functional substance optionally present, steps (d) and (e) possibly being simultaneous.

3. The method as claimed in claim 1, characterized by the fact that it comprises the step (c) of introducing at least one functional substance (component 4).

4. The method as claimed in claim 1, characterized by the fact that the plasticizer (component 2) is chosen from diols, triols, polyols, salts of organic acids, urea and mixtures of these products.

5. The method as claimed in claim 4, characterized by the fact that the plasticizer is chosen from glycerol, polyglycerols, isosorbide, sorbitans, sorbitol, mannitol, hydrogenated glucose syrups, sodium lactate, and mixtures of these products.

6. The method as claimed in claim 1, characterized by the fact that the plasticizer is incorporated into the granular starch in an amount of 10 to 150 parts by weight, preferably in an amount of 25 to 120 parts by weight and in particular in an amount of 40 to 120 parts by weight per 100 parts by weight of starch.

7. The method as claimed in claim 1, characterized in that the coupling agent is chosen from the following compounds:
diisocyanates and polyisocyanates, preferably 4,4′-dicyclohexylmethane diisocyanate (H12MDI), methylene diphenyl diisocyanate (MDI), toluene diisocyanate (TDI), naphthalene diisocyanate (NDI), hexamethylene diisocyanate (HMDI) and lysine diisocyanate (LDI);
dicarbamoylcaprolactams, preferably 1,1′carbonylbiscaprolactam;
diepoxides;
halohydrins, preferably epichlorohydrin;
organic diacids, preferably succinic acid, adipic acid, glutaric acid, oxalic acid, malonic acid, maleic acid and the corresponding anhydrides;
oxychlorides, preferably phosphorus oxychloride;
trimetaphosphates, preferably sodium trimetaphosphate;
alkoxysilanes, preferably tetraethoxysilane, and any mixtures of these compounds.

8. The method as claimed in claim 7, characterized by the fact that the coupling agent is chosen from diisocyanates, diepoxides and halohydrins.

9. The method as claimed in claim 8, characterized by the fact that the coupling agent is a diisocyanate, preferably methylene diphenyl diisocyanate (MDI) or 4,4′-dicyclohexylmethane diisocyanate (H12MDI).

10. The method as claimed in claim 1, characterized in that the amount of coupling agent used is between 0.01 and 15 parts, preferably between 0.1 and 12 parts and better still between 0.1 and 9 parts per 100 parts of plasticized composition from step (b), optionally also containing a functional substance (component 4).

11. The method as claimed in claim 1, characterized in that the granular starch (component 1) is a native starch of cereal plants, tubers or leguminous plants, a starch hydrolyzed by an acid, oxidizing or enzymatic route, an oxidized starch, a white dextrin, an esterified and/or etherified starch or a starch that has undergone a treatment in an aqueous medium at low temperature (annealing treatment).

12. The method as claimed in claim 1, characterized in that the plasticized composition, optionally containing a functional substance (component 4), is dried or dehydrated, before the incorporation of the coupling agent, to a residual moisture content of less than 5%, preferably less than 1%, in particular less than 0.1%.

13. A thermoplastic starch-based composition capable of being obtained by a method as claimed in claim 1.

14. A thermoplastic starch-based composition capable of being obtained by a method as claimed in claim 2, characterized in that it has an insolubles content in water, at 20° C., greater than 72%, preferably greater than 80%, in particular greater than 90%.

15. The composition as claimed in claim 14, characterized in that it has, after immersion in water at 20° C. for 24 hours, a degree of swelling of less than 20%, preferably less than 12%, better still less than 6%.

16. The composition as claimed in claim 14, characterized in that it has an elongation at break greater than 40%, preferably greater than 80% and in particular greater than 90%.

17. The composition as claimed in claim 14, characterized in that it has a maximum tensile strength greater than 4 MPa, preferably greater than 6 MPa and in particular greater than 8 MPa.

18. The composition as claimed in claim 14, characterized in that it has:
an insolubles content at least equal to 98%;
a degree of swelling of less than 5%;
an elongation at break at least equal to 95%; and
a maximum tensile strength greater than 8 MPa.

19. The composition as claimed in claim 13, characterized in that it is not biodegradable or not compostable within the meaning of the EN 13432, ASTM D6400 and ASTM 6868 standards.

20. The composition as claimed in claim 13, characterized in that it contains at least 33%, preferably at least 50% of carbon of renewable origin within the meaning of the ASTM D6852 standard.

21. The composition as claimed in claim 13, characterized by the fact that it contains, as functional substance, a polymer chosen from functionalized polyethylenes (PEs) and polypropylenes (PPs), functionalized styrene-ethylene-butylene-styrene copolymers (SEBSs), amorphous polyethylene terephthalates and thermoplastic polyurethanes (TPUs).
